(19) United States
(12) Patent Application Publication
(10) Pub. No.: US 2011/0253777 A1
(43) Pub. Date: Oct. 20, 2011

(54) MERCHANDIZING CARTON

(75) Inventors: Thomas E. Ciecorka, Suwanee, GA (US); Yavuz Aksan, Suwanee, GA (US)

(73) Assignee: GEORGIA-PACIFIC CORRUGATED LLC., Atlanta, GA (US)

(21) Appl. No.: 13/089,746

(22) Filed: Apr. 19, 2011

Related U.S. Application Data
(60) Provisional application No. 61/325,862, filed on Apr. 20, 2010.

(51) Int. Cl. B65D 5/32; B65D 5/70; B31B 1/62; B65D 5/72

(52) U.S. Cl. 229/122.27; 206/758; 229/240; 229/125.01; 493/210; 493/264

(57) ABSTRACT

A carton includes a base member comprising, a bottom portion, a pair of longitudinal base walls, a first transverse base wall, and a second transverse base wall, and a panel disposed adjacent to the second transverse base wall in an interior space partially defined by the base member, the panel operative to be biased by a following mechanism.

### CROSS-REFERENCE TO RELATED APPLICATION

This application claims the benefit of U.S. Provisional Application No. 61/325,862, filed Apr. 20, 2010, the entirety of which is herein incorporated by reference.

### BACKGROUND OF THE INVENTION

The subject matter disclosed herein relates to merchandizing cartons.

Products may be packaged and shipped in cartons to a retail location. The retail location may include shelving having mechanical devices that exert a force on a row of products such that when a customer removes a product from the row, another product in the row is pushed to the front of the shelf.

### BRIEF DESCRIPTION OF THE INVENTION

According to one aspect of the invention, a carton includes a base member comprising, a bottom portion, a pair of longitudinal base walls, a first transverse base wall, and a second transverse base wall, and a panel disposed adjacent to the second transverse base wall in an interior space partially defined by the base member, the panel operative to be biased by a following mechanism.

According to another aspect of the invention, a carton includes a base member comprising a bottom portion, a pair of longitudinal base walls, a first transverse base wall, and a second transverse base wall including at least one break away region in the second transverse wall, and a lid member comprising a top portion, a pair of longitudinal lid walls, a first transverse lid wall, and a second transverse lid wall comprising a detachable panel in the second transverse lid wall, the detachable panel is attached to the at least one break away region of the second transverse base wall with an adhesive.

According to another aspect of the invention, a method for fabricating a carton, the method includes forming a base member from a first unitary continuous carton blank, the base member comprising a bottom portion, a pair of longitudinal base walls, a first transverse base wall, and a second transverse base wall comprising at least one break away region in the second transverse base wall, and forming a lid portion from a second unitary continuous carton blank, the lid portion comprising a top portion, a pair of longitudinal lid walls, a first transverse lid wall, and a second transverse lid wall comprising a detachable panel in the second transverse lid wall.

According to yet another aspect of the invention, a carton includes a base member comprising a bottom portion, a pair of longitudinal base walls, a first transverse base wall, a second transverse base wall, and an orifice at least partially defined in the second transverse base wall, and a detachable panel attached to a portion of the second transverse base wall, wherein the detachable panel is operative to be biased by a following mechanism contacting the detachable panel in a region partially defined by the orifice.

These and other advantages and features will become more apparent from the following description taken in conjunction with the drawings.

### BRIEF DESCRIPTION OF THE DRAWINGS

The subject matter, which is regarded as the invention, is particularly pointed away and distinctly claimed in the claims at the conclusion of the specification. The foregoing and other features, and advantages of the invention are apparent from the following detailed description taken in conjunction with the accompanying drawings in which:

FIG. 1 illustrates a perspective view of an assembled carton.

FIG. 2 illustrates a perspective view of a base member and a lid portion of the carton of FIG. 1.

FIG. 3 illustrates the carton on a merchandizing display.

FIG. 4 illustrates a schematic diagram of the base member of FIG. 2.

FIG. 5 illustrates a schematic diagram of the lid portion of FIG. 2.

FIG. 6 illustrates a schematic diagram of an alternate embodiment of the base member.

The detailed description explains embodiments of the invention, together with advantages and features, by way of example with reference to the drawings, wherein like elements are referenced alike.

### DETAILED DESCRIPTION OF THE INVENTION

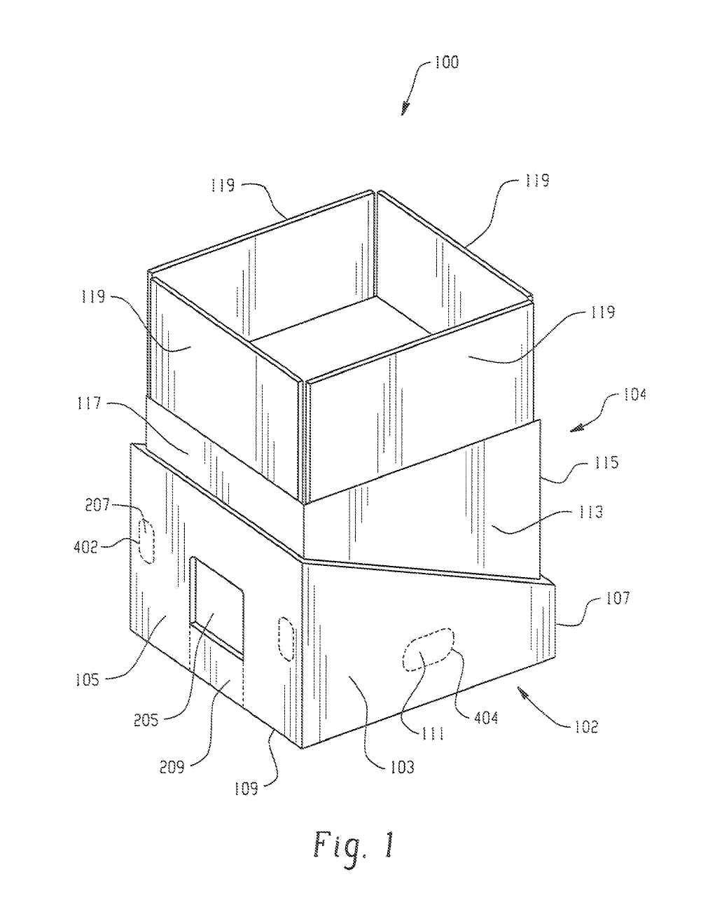

FIG. 1 illustrates a perspective view of an exemplary embodiment of an assembled carton 100. The carton 100 includes a base member 102 and a lid portion 104. The base member 102 includes side (longitudinal) walls 103, a rear (transverse) wall 105, a front (transverse) wall 107 and a bottom portion 109, and is formed from corresponding panels and flaps on a unitary continuous carton blank. In the illustrated embodiment, the side (longitudinal) walls 103 include a break away region 111. The break away region 111 is defined at least in part by perforations. In the illustrated embodiment, the break away region 111 is formed in an oblong oval shape however; the break away region 111 may be formed in any alternate appropriate shape. While break away regions are illustrated herein being defined by perforations, it will be appreciated that there may be other means of forming break away regions, such as by using a combination of perforation lines and cut lines, for example, which is considered within the scope of the invention disclosed herein. The terms such as, for example, “top”, “bottom”, “front”, “back”, “longitudinal”, and “transverse” used herein are merely intended for ease of describing the relationship of structural elements that could be oriented in alternative ways.

In one embodiment, the lid portion 104 includes side walls 113, a front wall 115, a rear wall 117, and a plurality of top walls 119, and is formed from corresponding panels and flaps on a unitary continuous carton blank. The top walls 119 are foldably joined to the lid portion 104 and may be folded and secured to each other with, for example, an adhesive or adhesive backed tape to form a secure top of the carton 100.

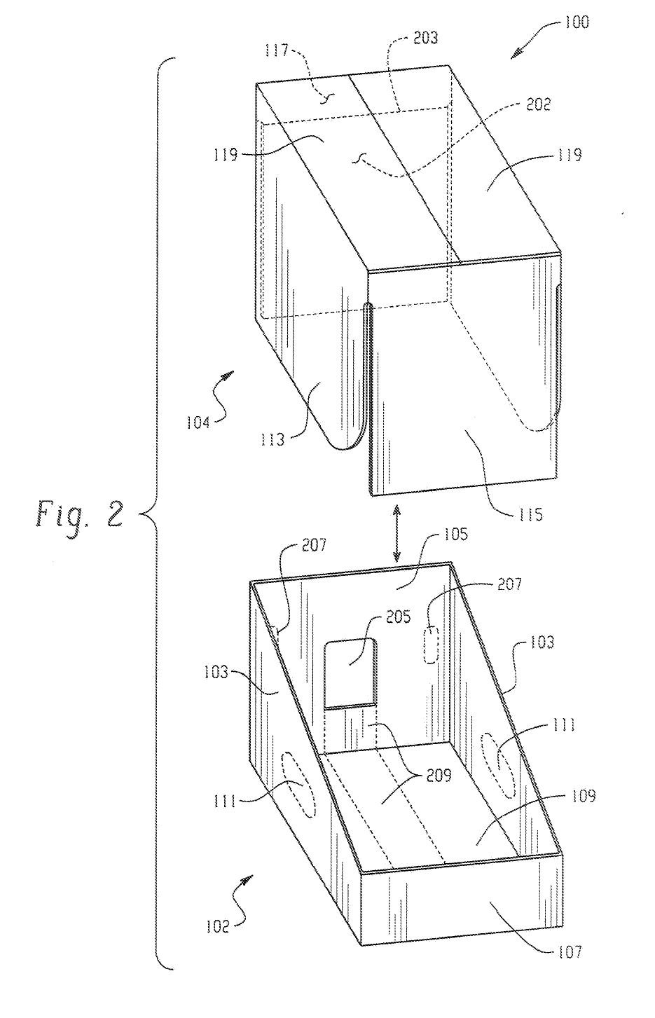

FIG. 2 illustrates a perspective view of the base member 102 and the lid portion 104 of the carton 100 prior to assembly. FIG. 2 illustrates the rear wall 117 of the lid portion 104. The rear wall 117 includes a detachable panel 202 that is partially defined by a perforated line 203. The rear (transverse) wall 105 of the base member 102 includes a cut out region 205, and break away regions 207. The break away regions 207 are defined by perforations and are similar to the break away regions 111 (of FIG. 1). The carton 100 may also include a break away channel region 209 on the rear (transverse) wall 105 and the bottom portion 109 that is defined by perforations. In alternate embodiments, the break away channel region 209 may be merely defined by a portion of the rear (transverse wall 105) such that the bottom portion 109 may remain intact, while the break away channel region 209 may be removed from the portion of the rear (transverse) wall.

Though the illustrated embodiment includes the detachable panel 202 as being partially defined by the perforated line 203, alternate embodiments may include the detachable panel 202 (not part of rear wall 117 or lid portion 104) as being disposed adjacent to the rear (transverse) wall 105 such that the detachable panel 202 is arranged in parallel to the rear (transverse) wall 105. In such an arrangement, the detachable panel 202 may be provided as a separate component that is disconnected from the lid portion 104. The detachable panel 202 may be, but is not limited to being connected to the break away regions 207.

Though the illustrated embodiment includes a lid portion 104 formed from a unitary continuous carton blank that may engage the base member 102, one of ordinary skill in the art would understand that in an alternate embodiment, the lid portion 104 may be formed as a continuous portion of the base member 102 such that, for example, the side walls 113, front wall 115, rear wall 117, and plurality of top walls 119 may be formed from a unitary continuous carton blank with the corresponding side longitudinal walls 103, rear transverse wall 105, front transverse wall 107 and bottom portion 109 base member 102. In such an embodiment, the detachable panel 202 may be formed from a separate panel from the unitary continuous carton blank that would form the base member 102 and the lid portion 104.

In one embodiment, when assembled, the lid portion 104 slidably engages the base member 102 such that the outer surfaces of the side walls 113, front wall 115, and rear wall 117 of the lid portion 104 contact the inner surfaces of the side (longitudinal) walls 103, rear (transverse) wall 105, and front (transverse) wall 107 of the base member 102. The detachable panel 202 overlaps the cut out region 205 such that the interior space of the base member 102 is inaccessible when the carton 100 is assembled and the break away regions 111 and 207 are in place. The lid portion 104 is secured to the base member 102 by an adhesive such as, for example, a glue, resin, or epoxy, that is applied to the inner surfaces of the break away regions 111 (of FIG. 1) and 207. The adhesive bonds the break away regions 111 to the side walls 113 of the lid portion 104 and the break away regions 207 to detachable panel 202 of the rear wall 117 of the lid portion 104.

In one instance, when the carton 100 is prepared by a user for placement in a merchandizing display, a user may exert a compressive force on the side walls 113 and/or the break away regions 111. The compressive force breaks the perforated connections between the break away regions 111 and the side (longitudinal) walls 103 of the base member 102. The adhesive bond between the break away regions 111 and the side walls 113 of the lid portion 104 should remain intact. The user may exert a force on the lid portion 104 that breaks the perforated connection between the detachable panel 202 and lid portion 104. The adhesive bond between the break away regions 207 and the detachable panel 202 should remain intact such that the detachable panel 202 remains connected to the base member 102. The remainder of the lid portion 104 may be detached from the base member 102 and discarded. The perforations that define the break away channel region 209 on the rear (transverse) wall 105 and the bottom portion 109 may also be removed.

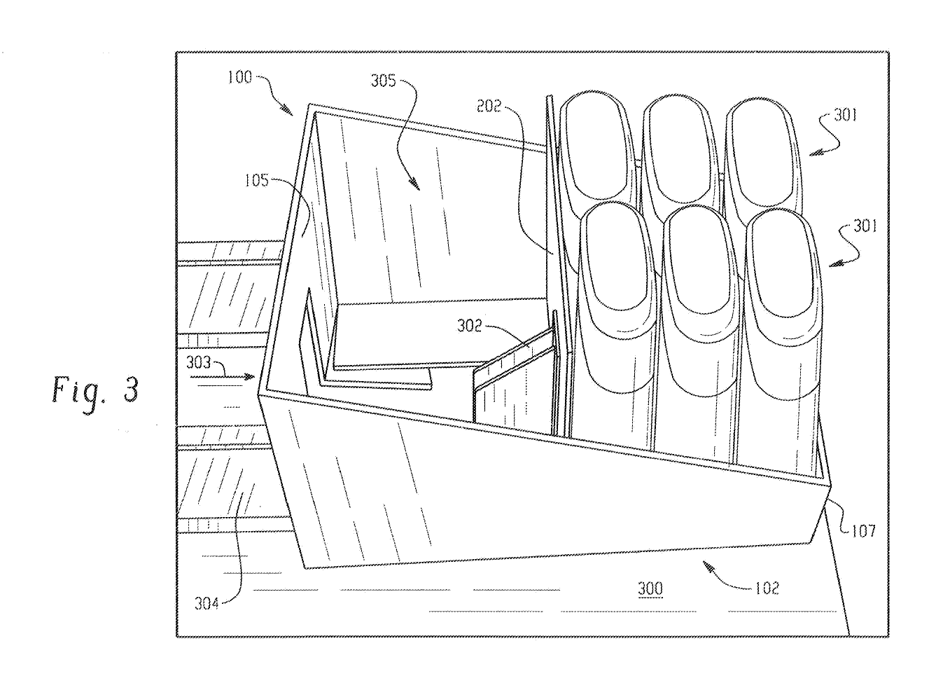

FIG. 3 illustrates the carton 100 that has been placed by a user on a merchandizing display with the lid portion 104 removed in the manner discussed above. The merchandizing display may include a shelf 300 and a mechanical device that includes a following element 302 mechanically connected to a base element 304. The base element 304 is secured to the shelf 300, and includes a biasing element (not shown) such as, for example, a spring that exerts a linear force on the following element 302 biasing the following element 302 in the direction of a lip of the shelf 300 illustrated by the arrow 303. An interior space 305 of the carton 100 is defined by base member 102. The interior space 305 of the carton 100 is loaded with products arranged in product rows 301. Though the illustrated exemplary embodiment includes two product rows 301, alternate embodiments may include any number of product rows 301.

In one exemplary operation, a user may place the base member 102 on the shelf 300 such that the following element 302 contacts the detachable panel 202 in the break away channel region 209. The user may exert a linear force on the base member 102 opposing the biasing force exerted on the following element 302. The opposing forces break the perforated connection between the break away regions 207 and the rear (transverse) wall 105 such that the detachable panel 202 is detached from the rear (transverse) wall 105 and driven with a compressive force by the following element 302 in the direction 303. In another embodiment, the shelf 300 may include an impinging element (not shown) arranged near the lip of the shelf 300. The front (transverse) wall 107 of the base member 102 contacts the impinging element and opposes the force exerted by the following element 302.

In another embodiment, the biasing force from the following element 302 may be exerted on the detachable panel 202 that in turn, exerts a force on the rear most product in the rows of products 301. The detachable panel 202 is aligned substantially orthogonal to the side (longitudinal) walls 103 (of FIG. 1) of the base member 102. When a product is removed from one of the rows of products 301, the rows of products 301 are pushed forward (in the direction 303) towards the lip of the shelf 300.

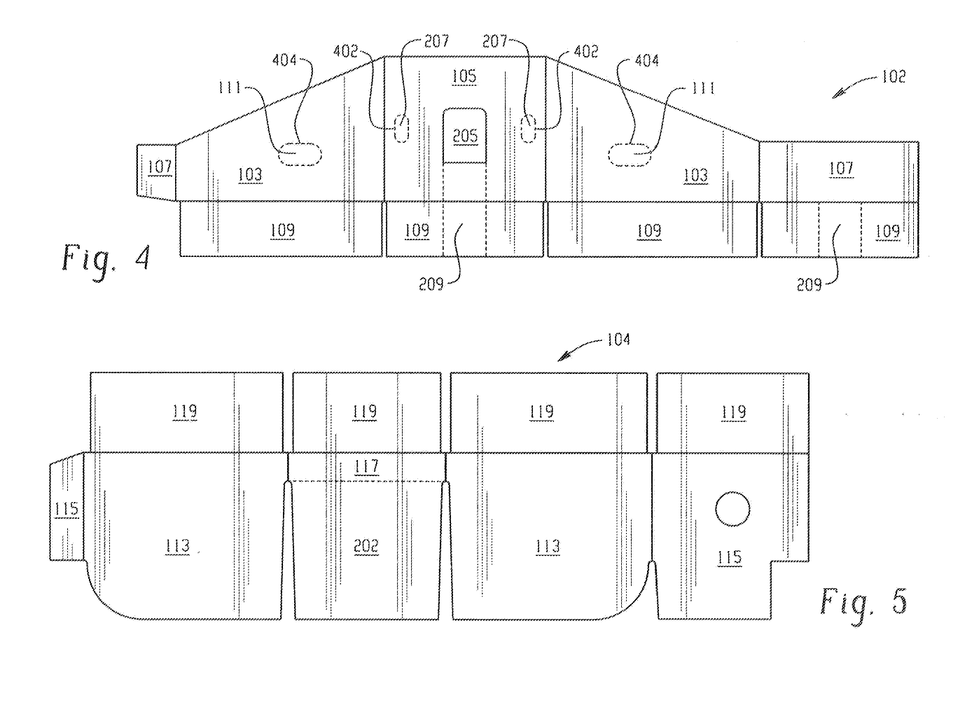

FIG. 4 illustrates a schematic diagram of a unitary continuous carton blank of the base member 102 prior to foldably assembling the base member 102. The illustrated embodiment includes lines 402 and 404 that define the break away regions 207 and 111. As discussed above, the lines 402 and 404 represent perforations (illustrated by dashed lines) or cut lines (illustrated by solid lines) that allow the break away regions 207 and 111 to be removed by a user. The base member 102 and lid portion 104 (of FIG. 1) may be formed from for example, a sheet product such as a corrugated sheet product. Further, sheet products may contain fibrous cellulosic materials that may be derived from natural sources, such as wood pulp fibers, as well as other fibrous material characterized by having hydroxyl groups attached to the polymer backbone. These include, but are not limited to, glass fibers and synthetic fibers modified with hydroxyl groups. The base member 102 is assembled by folding the base member 102 along defined folding regions (illustrated by solids lines between adjacent walls or adjacent walls and bottom portions). Once folded, the panels of the carton 100 may be secured together using any suitable method such as, for example, an adhesive such as, for example, a glue, epoxy, or resin or an adhesive tape material.

FIG. 5 illustrates a schematic diagram of a unitary continuous carton blank of the lid portion 104 prior to foldably assembling the lid portion 104. The unitary continuous carton blank of the lid portion 104 includes the side walls 113, the front wall 115, the rear wall 117, and the plurality of top walls 119 described above.

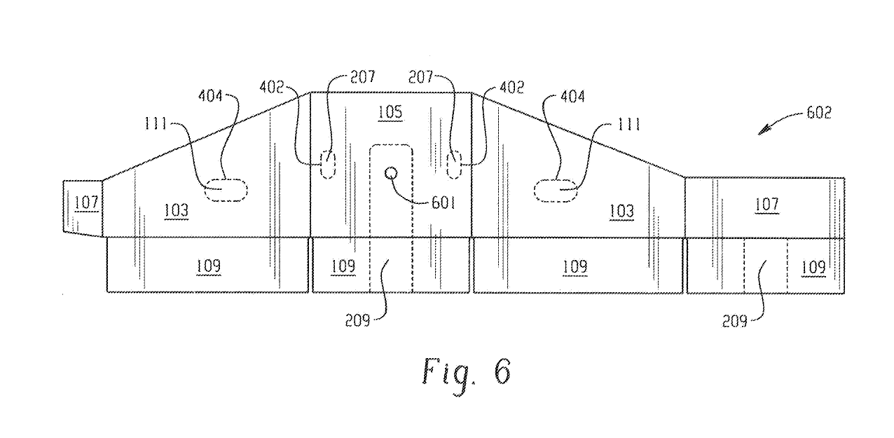

FIG. 6 illustrates a schematic diagram of a unitary continuous carton blank of an alternate embodiment of a base member 602 prior to foldably assembling the base member 602. The base member 602 is similar to the base member 102 (of FIG. 4) described above, however the base member 602 does not include the cut out region 205 (of FIG. 4). The base member 602 may include a finger hole 601 in some embodiments. In other embodiments, the base member 602 may include a perforated portion operative to define a region similar to the region 205 described above.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A carton comprising:
a base member comprising:
a bottom portion;
a pair of longitudinal base walls;
a first transverse base wall; and
a second transverse base wall; and
a panel disposed adjacent to the second transverse base wall in an interior space partially defined by the base member, the panel operative to be biased by a following mechanism.

2. The carton of claim 1, wherein the second transverse base wall includes at least one break away region.

3. The carton of claim 2, wherein the panel disposed adjacent to the second transverse base wall is attached to the at least one break away region of the second transverse base wall.

4. The carton of claim 3, wherein the panel is attached to the at least one break away region with an adhesive.

5. The carton of claim 1, wherein the carton includes an opening defined by the second transverse base wall.

6. The carton of claim 1, wherein the carton includes a lid portion including:
a top portion;
a pair of longitudinal lid walls;
a first transverse lid wall; and
a second transverse lid wall.

7. The carton of claim 6, wherein the second transverse lid wall includes the panel, the panel attached to the second transverse wall by perforations.

8. The carton of claim 6, wherein outer surfaces of the pair of longitudinal lid walls contact inner surfaces of the pair of longitudinal base walls, each longitudinal base wall including at least one break away region, each of the longitudinal lid walls attached to the corresponding at least one break away region of the longitudinal base walls.

9. The carton of claim 1, wherein the carton includes a removable portion in the second transverse base portion.

10. The carton of claim 1, wherein the carton includes a removable portion at least partially defined by perforations in the bottom portion.

11. The carton of claim 1, wherein the base portion is formed from a unitary continuous carton blank.

12. A carton comprising:
a base member comprising:
a bottom portion;
a pair of longitudinal base walls;
a first transverse base wall; and
a second transverse base wall including at least one break away region in the second transverse wall; and
a lid member comprising:
a top portion;
a pair of longitudinal lid walls;
a first transverse lid wall; and
a second transverse lid wall comprising a detachable panel in the second transverse lid wall, the detachable panel is attached to the at least one break away region of the second transverse base wall with an adhesive.

13. The carton of claim 12, wherein the carton includes an opening defined in the second transverse base wall.

14. The carton of claim 12, wherein outer surfaces of the pair of longitudinal lid walls contact inner surfaces of the pair of longitudinal base walls, each longitudinal base wall of the pair of longitudinal base walls including at least one break away region in each longitudinal base wall, each of the longitudinal lid walls attached to the corresponding at least one break away region of the longitudinal base walls.

15. The carton of claim 12, wherein the carton includes a removable portion in the bottom portion and the second transverse base portion.

16. The carton of claim 12, wherein the base portion is formed from a first unitary continuous carton blank.

17. The carton of claim 12, wherein the lid portion is formed from a second unitary continuous carton blank.

18. A method for fabricating a carton, the method comprising:
forming a base member from a first unitary continuous carton blank, the base member comprising:
a bottom portion;
a pair of longitudinal base walls;
a first transverse base wall; and
a second transverse base wall comprising at least one break away region in the second transverse base wall; and
forming a lid portion from a second unitary continuous carton blank, the lid portion comprising:
a top portion;
a pair of longitudinal lid walls;
a first transverse lid wall; and
a second transverse lid wall comprising a detachable panel in the second transverse lid wall.

19. The method of claim 18, wherein the method includes attaching the detachable panel to the at least one break away region of the second transverse base wall with an adhesive.

20. The method of claim 18, wherein the method includes forming at least one break away region in each longitudinal base wall.

21. The method of claim 20, wherein the method includes:
arranging the base member and the lid portion such that the outer surfaces of the pair of longitudinal lid walls contact inner surfaces of the pair of longitudinal base walls; and
attaching each of the longitudinal lid walls to the corresponding at least one break away regions of the longitudinal base walls with an adhesive.

22. A carton comprising:
a base member comprising:
a bottom portion;
a pair of longitudinal base walls;
a first transverse base wall;
a second transverse base wall; and
an orifice at least partially defined in the second transverse base wall; and
a detachable panel attached to a portion of the second transverse base wall, wherein the detachable panel is operative to be biased by a following mechanism contacting the detachable panel in a region partially defined by the orifice.

23. The carton of claim 22, wherein the second transverse base wall includes at least one break away region defined at least in part by perforations in the second transverse wall, and the detachable panel is attached to the at least one break away region of the second transverse base wall, wherein the detachable panel is operative to be detached from the second transverse base wall by the following mechanism.

24. The carton of claim 22, wherein the following mechanism is operative to impart a force on the detachable panel, the detachable panel in contact with at least one row of products disposed in the base member.

25. The carton of claim 22, wherein the orifice is partially defined by the bottom portion.
